(19) United States
(12) Patent Application Publication
(10) Pub. No.: US 2016/0204500 A1
(43) Pub. Date: Jul. 14, 2016

(54) ANTENNA DEVICE AND COMMUNICATION DEVICE

(71) Applicant: DEXERIALS CORPORATION, Tokyo (JP)

(72) Inventors: Katsuhisa ORIHARA, Utsunomiya-shi, Tochigi (JP); Manabu SUZUKI, Nogi-machi, Tochigi (JP)

(73) Assignee: Dexerials Corporation, Shinagawa-ku, Tokyo (JP)

(21) Appl. No.: 14/912,459

(22) PCT Filed: Aug. 19, 2014
(86) PCT No.: PCT/JP2014/071613

§ 371 Date: Feb. 17, 2016

(30) Foreign Application Priority Data
Aug. 22, 2013 (JP) 2013-171951

(51) Int. Cl. H01Q 1/24; H01Q 7/06; H01Q 1/38

(52) U.S. Cl. CPC H01Q 1/243; H01Q 1/38; H01Q 7/06

(57) ABSTRACT

An antenna device is incorporated into an electronic apparatus and is able to communicate by receiving a magnetic field transmitted from a reader/writer (120). The antenna device includes an antenna substrate (11), an antenna coil (11a) formed so as to loop around on one surface of the antenna substrate (11), a magnetic sheet (13) inserted into a central section of the antenna coil (11a) to pull in the magnetic field transmitted from the reader/writer (120), and a circuit section that is mounted in a shared circuit mounting region (20) provided on the other surface of the antenna substrate (11) at a position that avoids a position at which the magnetic sheet (13) is inserted and that is connected to an external circuit. At least part of a winding wire of the antenna coil (11a) surrounds at least a portion of circuit components forming the circuit section.

### TECHNICAL FIELD

The present disclosure relates to an antenna device and a communication device that are incorporated into an electronic apparatus and that are able to communicate by receiving a magnetic field transmitted by a transmitter. The present application claims priority based on Japanese Patent Application No. 2013-171951, filed in Japan on Aug. 22, 2013, the contents of which are incorporated in the present application by reference.

### BACKGROUND

Antenna modules for RFID (Radio Frequency Identification) are for example used in order to provide electronic apparatuses, such as mobile telephones, with a short-distance contactless communication function.

An antenna module such as described above communicates with a transmitter, such as a reader/writer, through inductive coupling with an antenna coil included in the transmitter. In other words, an antenna coil of the antenna module receives a magnetic field from the reader/writer and converts the magnetic field to electricity to drive an IC that serves as a communication processor.

In order for the antenna module to communicate reliably, it is necessary for the antenna coil to receive magnetic flux of at least a certain value from the reader/writer. Therefore, in a conventional example of an antenna module, a loop coil is provided in a housing of a mobile telephone and the loop coil receives magnetic flux from a reader/writer.

However, when an antenna module is incorporated into an electronic apparatus, such as a mobile telephone, metal included in a substrate, battery pack, or the like within the electronic apparatus also receives a magnetic field from a reader/writer, leading to production of an eddy current in the metal. Consequently, magnetic flux reaching a loop coil of the antenna module from the reader/writer is reduced due to bouncing back of the magnetic flux. In consideration of the reduction in magnetic flux reaching the loop coil, the antenna module requires the loop coil to have an aperture of sufficient size for collecting the necessary magnetic flux and requires a magnetic sheet for increasing magnetic flux collection in the aperture section.

As described above, the flow of an eddy current in a substrate of an electronic apparatus, such as a mobile telephone, causes bouncing back of magnetic flux transmitted from a reader/writer. PTL 1 proposes, however, that a magnetic field component oriented in a surface direction of the substrate is present at the surface of a housing of the electronic apparatus and that the function of an antenna can be performed by receiving the aforementioned magnetic field component. PTL 1 specifically proposes an antenna structure in which a coil is wrapped around a ferrite core in order to reduce the area occupied by the coil.

### CITATION LIST

### Patent Literature

PTL 1: JP2008-35464 A

### SUMMARY

### Technical Problem

An antenna module such as described above is electrically connected to a communication processor that performs transmission and reception, and communicates with electronic apparatus such as a reader/writer or a contactless IC card. Due to high frequency wave modulation for transmitted and received signals, it is necessary to perform matching of input/output impedance of the communication processor and input/output impedance of the antenna module in order to ensure communication characteristics such as transmission and reception efficiency and coupling coefficient. Furthermore, a matching circuit that performs impedance matching with the communication processor may be mounted in the antenna module in order to allow for reduction in size of a device into which the antenna module is incorporated. As described further above, antenna communication characteristics can be improved by adding a magnetic sheet to the antenna coil. However, in such a situation, a region in which the magnetic sheet is disposed can no longer be used for a circuit and, as a consequence, it is necessary to increase the size of an antenna substrate on which the antenna coil is formed in order to mount the matching circuit and so forth in the antenna module. Furthermore, providing space on the antenna substrate for a circuit is problematic as it reduces effective aperture area of the antenna and lowers communication characteristics.

The present disclosure is made in light of the situation described above and aims to provide an antenna device and a communication device that allow for a smaller and thinner housing of an electronic apparatus when incorporated into the electronic apparatus, while also maintaining communication characteristics.

### SOLUTION TO PROBLEM

In order to solve the above-described problem, an antenna device according to the present disclosure that is incorporated into an electronic apparatus and able to communicate by receiving a magnetic field transmitted from a transmitter includes a substrate, an antenna coil formed so as to loop around on one surface of the substrate, a magnetic sheet inserted into a central section of the antenna coil to pull in the magnetic field from the transmitter, and a circuit section including one or more circuit components that is formed on the other surface of the substrate at a position that avoids a position at which the magnetic sheet is inserted and that is connected to an external circuit. At least part of a winding wire of the antenna coil surrounds the circuit section.

Furthermore, a communication device according to the present disclosure that is incorporated into an electronic apparatus and able to communicate by receiving a magnetic field transmitted from a transmitter includes an antenna device. The antenna device includes a substrate, an antenna coil formed so as to loop around on one surface of the substrate, a magnetic sheet inserted into a central section of the antenna coil to pull in the magnetic field from the transmitter, and a circuit section including one or more circuit components that is formed on the other surface of the substrate at a position that avoids a position at which the magnetic sheet is inserted and that is connected to an external circuit. In the antenna device, at least part of a winding wire of the antenna coil surrounds the circuit section.

### ADVANTAGEOUS EFFECT

As a result of the circuit section being located on the other surface of the substrate and at least part of the winding wire of the loop antenna encircling at least a portion of the circuit components of the circuit section, the present disclosure enables provision of the circuit section without reduction in aperture area of the loop antenna and enables reduction in size of the antenna device and the communication device.

### BRIEF DESCRIPTION OF THE DRAWINGS

In the accompanying drawings:

FIG. 1 illustrates configuration of a wireless communication system into which an antenna device and a communication device according to the present disclosure are incorporated;

FIG. 2A is a plan view, FIG. 2B is a bottom view, and FIG. 2C is a cross-sectional view from line AA′ in FIG. 2A, each illustrating an example of configuration of the antenna device according to one of the embodiments of this disclosure;

FIG. 3A is a plan view and FIG. 3B is a bottom view, each illustrating a modified example of configuration of the antenna device according to one of the embodiments of this disclosure;

FIG. 4 is an example of a circuit diagram of the antenna device to which the present disclosure is applied;

FIG. 5A is a plan view illustrating dimensions of an example of the antenna device, FIG. 5B is a plan view illustrating dimensions of a conventional antenna device used as a comparative example, and FIG. 5C is a plan view illustrating dimensions of an antenna device used as a reference example;

FIG. 6A is a perspective view illustrating a measurement system for measuring communication characteristics with a reader/writer for the antenna devices of the example, the comparative example, and the reference example;

FIG. 6B illustrates the definition of an offset distance a; and

FIG. 7 is a graph in which a coupling coefficient measured for the antenna coil of each of the antenna devices is plotted against the offset distance a as a communication characteristic of the antenna device and the reader/writer.

### DETAILED DESCRIPTION

The following provides detailed description of an embodiment of the present disclosure with reference to the drawings. It should be noted that the present disclosure is not limited to the following embodiment and various alterations may of course be made without deviating from the essence of the present disclosure.

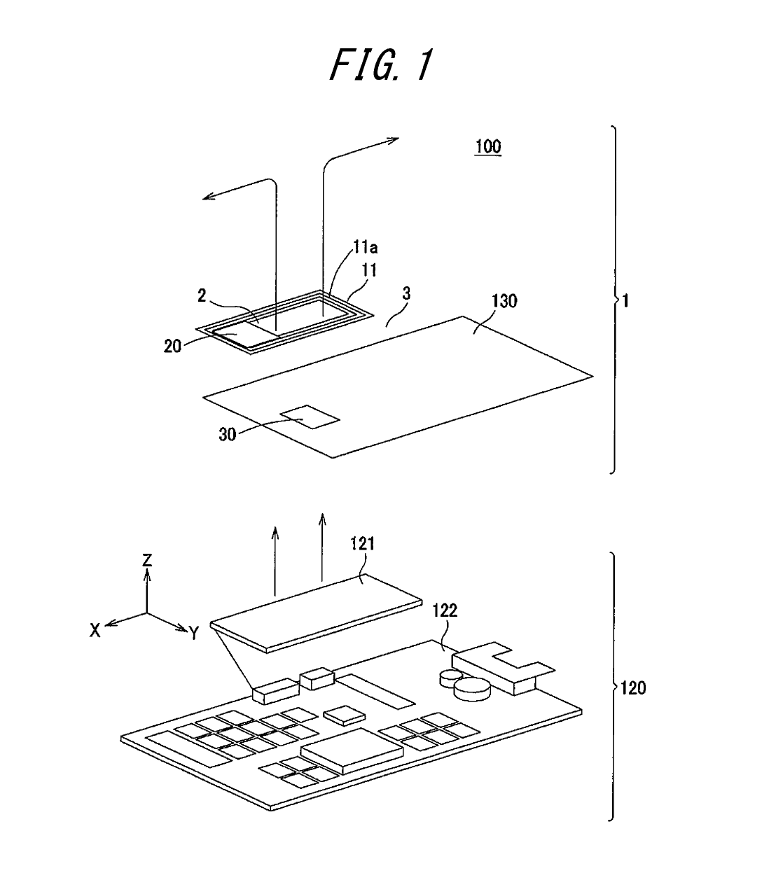

A communication device to which the present disclosure is applied is incorporated into an electronic apparatus and is able to communicate by receiving a magnetic field transmitted from a transmitter. For example, the communication device may be incorporated into and used in a wireless communication system 100 for RFID (Radio Frequency Identification) such as illustrated in FIG. 1.

The wireless communication system 100 includes a communication device 1 and a reader/writer 120 that accesses the communication device 1 in a contactless state. Herein, it is assumed that the communication device 1 and the reader/writer 120 are arranged so as to face each other in the xy plane of a three-dimensional orthogonal coordinate system xyz.

The reader/writer 120 functions as a transmitter configured to transmit a magnetic field in a positive direction along the z axis with respect to the communication device 1 facing the reader/writer 120 in the xy plane. Specifically, the reader/writer 120 includes an antenna 121 configured to transmit a magnetic field to the communication device 1 and a control substrate 122 configured to communicate with the communication device 1 by inductive coupling through the antenna 121.

In other words, the reader/writer 120 is provided with the control substrate 122, which is electrically connected to the antenna 121. On this control substrate 122, a control circuit including one or more electronic components such as integrated circuit chips is mounted. The control circuit performs various kinds of processing based on data received from the communication device 1. For example, when transmitting data to the communication device 1, the control circuit encodes the data, modulates a carrier wave of a predetermined frequency (for example, 13.56 MHz) based on the encoded data, amplifies the modulated signal, and drives the antenna 121 with the amplified modulated signal. Furthermore, when reading out via the communication device 1, the control circuit amplifies a modulated signal of data received by the antenna 121, demodulates the amplified modulated signal of the data, and decodes the demodulated data. The control circuit uses an encoding scheme and a modulation scheme that are employed in common reader/writers, such as Manchester encoding scheme and ASK (Amplitude Shift Keying) modulation scheme.

The communication device 1 is for example incorporated internally into a housing of a mobile telephone 130 that is arranged so as to face the reader/writer 120 in the xy plane. The communication device 1 includes an antenna module 2 having an antenna substrate 11 on which an antenna coil 11a that is able to communicate with the inductively coupled reader/writer 120 is provided.

The antenna coil 11a is formed on one surface of the antenna substrate 11 of the antenna module 2 by, for example, performing patterning of Cu or Al wiring by a printing technique on a flexible substrate made from polyimide or the like. A shared circuit mounting region 20 in which a matching circuit 28 and so forth are mounted is provided on the other surface of the antenna substrate 11. The matching circuit 28 is configured to perform impedance matching between the antenna coil 11a and a communication processor 30 that is external to the antenna module 2, and is electrically connected to the antenna coil 11a and the communication processor 30. The matching circuit 28 and so forth mounted in the shared circuit mounting region 20 and the antenna coil 11a are electrically connected by a commonly known technique such as a via hole. The antenna module 2 and the communication processor 30, which is mounted in a main body of the mobile telephone 130, are electrically connected by a connector or the like.

The antenna coil 11a receives the magnetic field transmitted from the reader/writer 120, inductively couples with the antenna 121 of the reader/writer 120, receives a modulated electromagnetic wave, and provides a received signal to the communication processor 30 mounted in the main body of the mobile telephone 130 through the matching circuit 28 and so forth. The communication processor 30 is driven by current flowing in the antenna coil 11a and communicates with the reader/writer 120. More specifically, the communication processor 30 demodulates the modulated signal that is received, decodes the demodulated data, and writes the decoded data into internal memory based on an instruction for the communication processor 30.

Furthermore, the communication processor 30 reads data from the internal memory that is to be transmitted to the reader/writer 120, encodes the read data, modulates a carrier wave based on the encoded data, and transmits a modulated radio wave to the reader/writer 120 through the antenna coil 11a, which is magnetically coupled to the reader/writer 120 by inductive coupling.

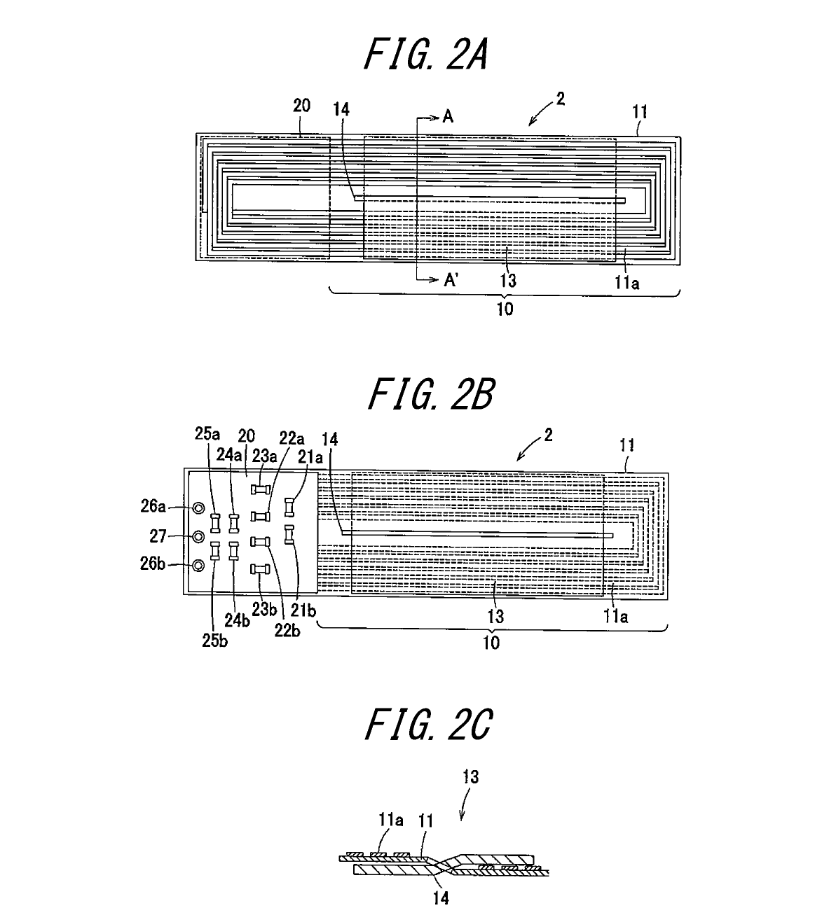

As illustrated in FIG. 2A, the antenna module 2 includes the antenna substrate 11 and the antenna coil 11a formed on one surface of the antenna substrate 11. The antenna substrate 11 is preferably a flexible printed substrate and is preferably a rectangular shape having long sides and short sides. The antenna coil 11a is a loop antenna that is formed so as to loop around on the antenna substrate 11 and is preferably a wiring pattern formed on the flexible printed substrate. The antenna coil 11a starts to wind from an outer edge of the antenna substrate 11 and winds inward on the antenna substrate 11 with a specific number of turns. A slit 14 that extends in the same direction as the long sides of the antenna substrate 11 is provided in an approximately central section of the antenna coil 11a. A magnetic sheet 13 configured to collect magnetic flux from the reader/writer 120 and to guide the magnetic flux to the antenna coil 11a is inserted into the slit 14. As explained further below, the shared circuit mounting region 20 is provided on the other surface of the antenna substrate 11 for mounting of the matching circuit 28 and so forth that connect the antenna coil 11a and the communication processor 30 and perform impedance matching thereof. Therefore, the slit 14 is formed at a position in an exclusive antenna coil region 10 that is adjacent to the shared circuit mounting region 20.

As illustrated in FIG. 2B, the shared circuit mounting region 20 is provided in the antenna module 2 on the other surface of the antenna substrate 11. The shared circuit mounting region 20 can be used for mounting of the matching circuit 28 and so forth that perform impedance matching with the communication processor 30 for transmission and reception, which is provided in the main body of the mobile telephone 130, and electrically connect to the antenna coil 11a. The shared circuit mounting region 20 is preferably located toward one of the short sides of the antenna substrate 11.

The shared circuit mounting region 20 includes, mounted therein, limiting resistors 21a and 21b configured to set a Q (Quality factor) value when a resonant circuit is formed by inductance of the antenna coil 11a and a resonant capacitor, matching capacitors 22a, 22b, 23a, and 23b configured to form the matching circuit 28 that performs impedance matching with the communication processor 30, and filter capacitors 24a and 24b and filter coils 25a and 25b configured to form a low-pass filter 29 for filtering a square wave signal from the communication processor 30. The shared circuit mounting region 20 further includes a ground terminal 27 and terminals 26a and 26b configured to connect to the communication processor 30 via the low-pass filter 29, the matching circuit 28, and so forth.

As illustrated in FIG. 2C, it is not possible to provide space for the matching circuit 28 and so forth in the exclusive antenna coil region 10 of the antenna substrate 11 in which the magnetic sheet 13 is inserted because one surface or the other surface of the antenna substrate 11 is covered by the magnetic sheet 13 in the exclusive antenna coil region 10. In consideration of the above, space can be provided for mounting of the matching circuit 28 and so forth by providing the shared circuit mounting region 20 on the other surface of the antenna substrate 11. In such a configuration, communication characteristics of the antenna module 2 can be maintained because the antenna coil 11a can loop along an antenna substrate periphery on the one surface of the antenna substrate 11 to ensure sufficient aperture area of the antenna coil 11a.

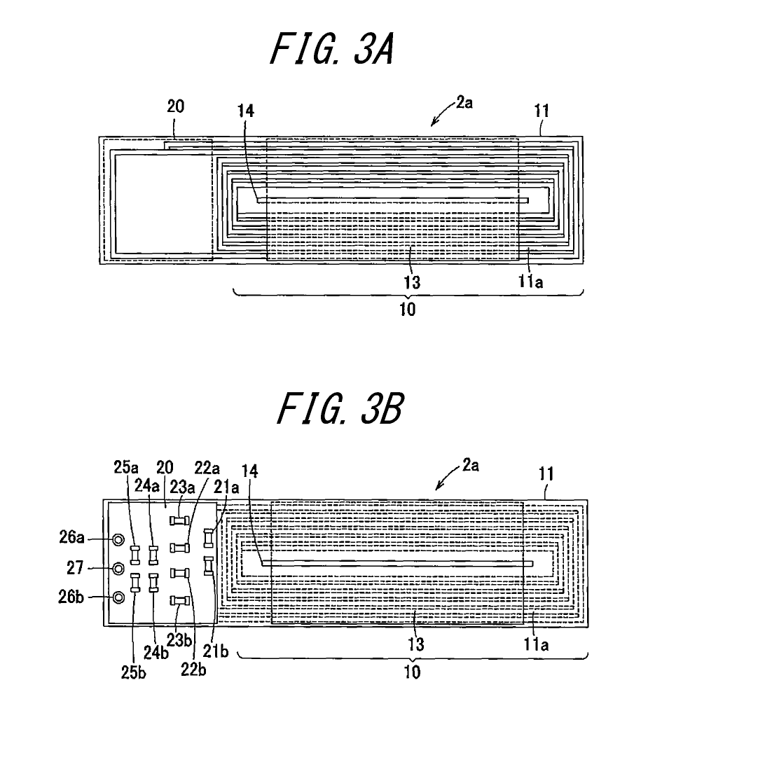

The antenna coil 11a is not limited to a configuration in which the antenna coil 11a starts winding from an outer edge of the antenna substrate 11 and winds along the outer edge of the antenna substrate 11 for each turn number. As illustrated in FIGS. 3A and 3B, in an alternative configuration, only part of the antenna coil 11a loops along the outer edge of the side of the antenna substrate 11 at which the shared circuit mounting region 20 is provided. In other words, in the same way as in FIGS. 2A to 2C, an antenna module 2a includes an antenna substrate 11, an antenna coil 11a formed on one surface of the antenna substrate 11, and a magnetic sheet 13 that is inserted into a slit 14 to collect a magnetic field from the antenna 121 of the reader/writer 120 and guide the magnetic field to the antenna coil 11a. The antenna module 2a also has a shared circuit mounting region 20 on the other surface of the antenna substrate 11 for mounting of a matching circuit 28 and so forth that electrically connect the antenna coil 11a and the communication processor 30 and perform impedance matching of the antenna coil 11a and the communication processor 30. In contrast to the configuration illustrated in FIGS. 2A to 2C in which the antenna coil 11a is formed on the antenna substrate 11 along the outer edge of the antenna substrate 11, in the present modified example, only an outermost section of the winding wire of the antenna coil 11a is formed along the outer edge of the antenna substrate 11 and winding wire of a second turn winds within the exclusive antenna coil region 10, adjacent to the shared circuit mounting region 20, on the antenna substrate 11. It should be noted that the antenna coil 11a is not limited to a configuration in which only the outermost section of winding wire—in other words, winding wire of a first turn—crosses from the exclusive antenna coil region 10 to the shared circuit mounting region 20, and winding from the exclusive antenna coil region 10 to the shared circuit mounting region 20 may for example continue until the second or third turn.

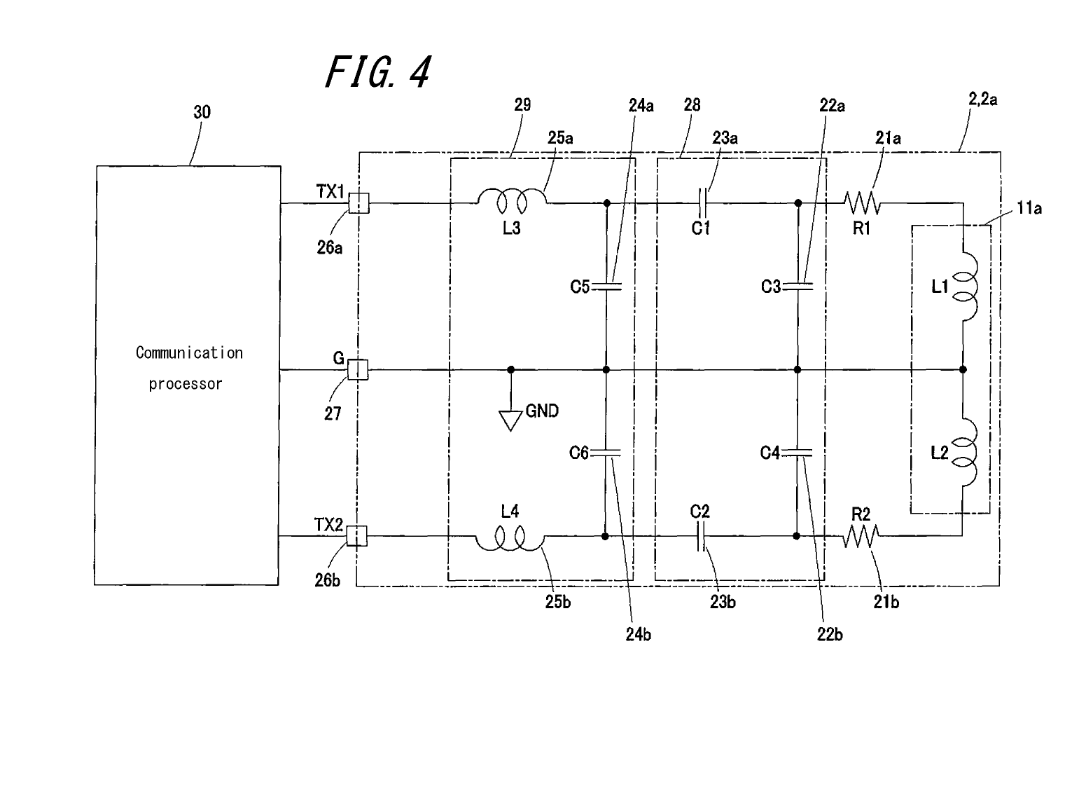

As illustrated for example in FIG. 4, the antenna module 2/2a to which the present disclosure is applied includes, on the antenna substrate, the antenna coil 11a, damping resistors (R1 and R2) 21a and 21b configured to adjust Q of a resonant circuit formed by the antenna coil 11a, the matching circuit 28 configured to perform impedance matching of the antenna coil 11a and a circuit connected to the antenna coil 11a, and the low-pass filter 29 configured to suppress spurious of a drive signal from the communication processor 30 for driving the antenna coil 11a, and these are in cascade connection. The communication processor 30 that exchanges transmission and reception signals with the antenna module 2/2a is connected to the antenna module 2/2a through connection terminals (TX1 and TX2) 26a and 26b, and a ground terminal (G) 27 of the antenna module 2/2a.

Although the circuit configuration described above is an example of a differential circuit configuration connected to a communication processor 30 having balanced input and output, it goes without saying that alternatively a single-ended circuit configuration for dealing with unbalanced input and output may be adopted, or low-pass filter circuit configuration may be changed. Furthermore, functional blocks of a circuit mounted in the shared circuit mounting region 20 are of course not limited to including all of the functional blocks described above; in one possible alternative example, only the matching circuit 28 is selected for mounting in the shared circuit mounting region 20.

Mounting of the matching circuit 28 and so forth in the antenna module 2/2a is advantageous in terms that a technical standards confirmation certificate for specific radio equipment can be received as an antenna module and an authentication procedure for the electronic apparatus into which the antenna module is incorporated can be simplified.

[Antenna module communication characteristics test]

A test was conducted in order to compare communication characteristics of an antenna module to which the present disclosure was applied and an antenna module having a conventional structure.

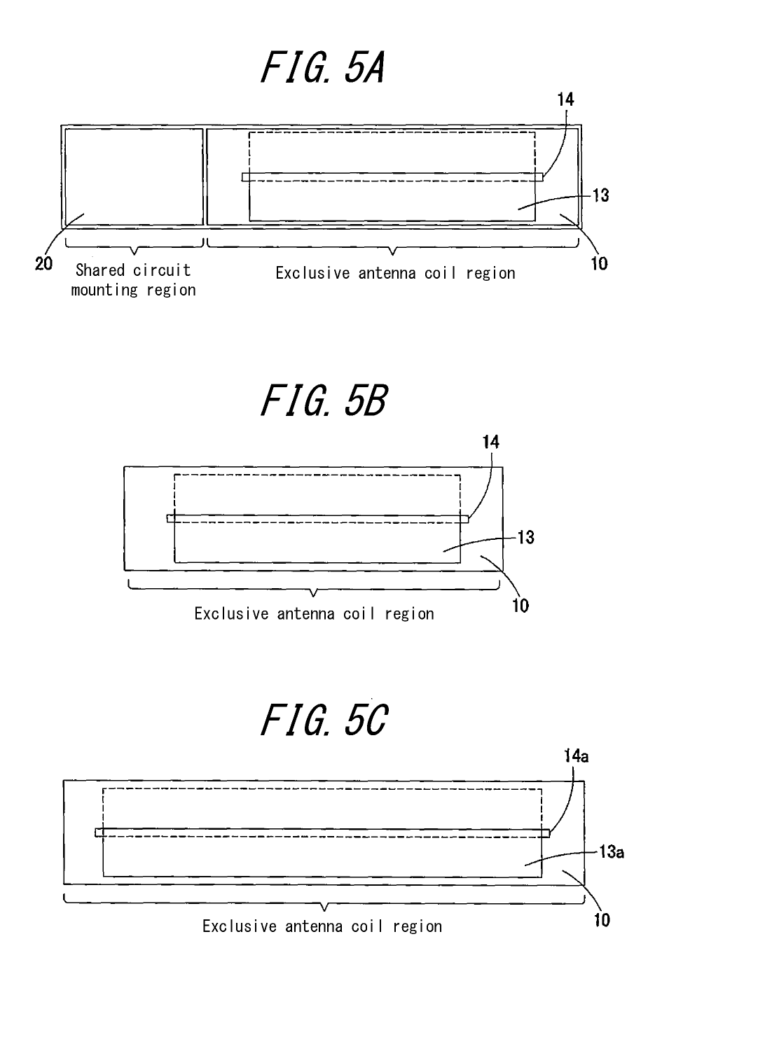

As illustrated in FIG. 5A, a shared circuit mounting region 20 was provided adjacent to an exclusive antenna coil region 10. A four turn antenna coil 11a was formed from Cu foil on one surface of a polyimide substrate. A magnetic sheet 13 made from Ni—Zn ferrite was inserted into a slit 14 that was only formed in the exclusive antenna coil region 10.

### Examples

In example 1, a first turn of the antenna coil 11a was formed along an outermost periphery of the polyimide substrate in FIG. 5A and second to fourth turns of the antenna coil 11a were formed within the exclusive antenna coil region 10.

In example 2, first to fourth turns of the antenna coil 11a were all formed along the periphery of the polyimide substrate in FIG. 5A, starting from an outermost periphery.

### Comparative Example

In a comparative example, a four turn antenna coil 11a was formed on a polyimide substrate as illustrated in FIG. 5B by starting winding of a first turn from an outermost periphery of the polyimide substrate. The size of the polyimide substrate was approximately the same as the exclusive antenna coil region 10 of the antenna module in FIG. 5A. Furthermore, the same Ni—Zn ferrite magnetic sheet 13 was inserted as in the antenna module in FIG. 5A. Dimensions of a slit 14 were also the same as in FIG. 5A.

### Reference Example

In a reference example, a four turn antenna coil 11a was formed on a polyimide substrate as illustrated in FIG. 5C by starting winding of a first turn from an outermost periphery of the polyimide substrate. The size of the polyimide substrate was the same as in FIG. 5A. A slit 14a having almost the same length as long sides of the polyimide substrate was formed in the polyimide substrate and a magnetic sheet 13a made from Ni—Zn ferrite was inserted into the slit 14a. Consequently, the magnetic sheet 13a was longer than the magnetic sheet 13 in each of FIGS. 5A and 5B.

### Measurement Method

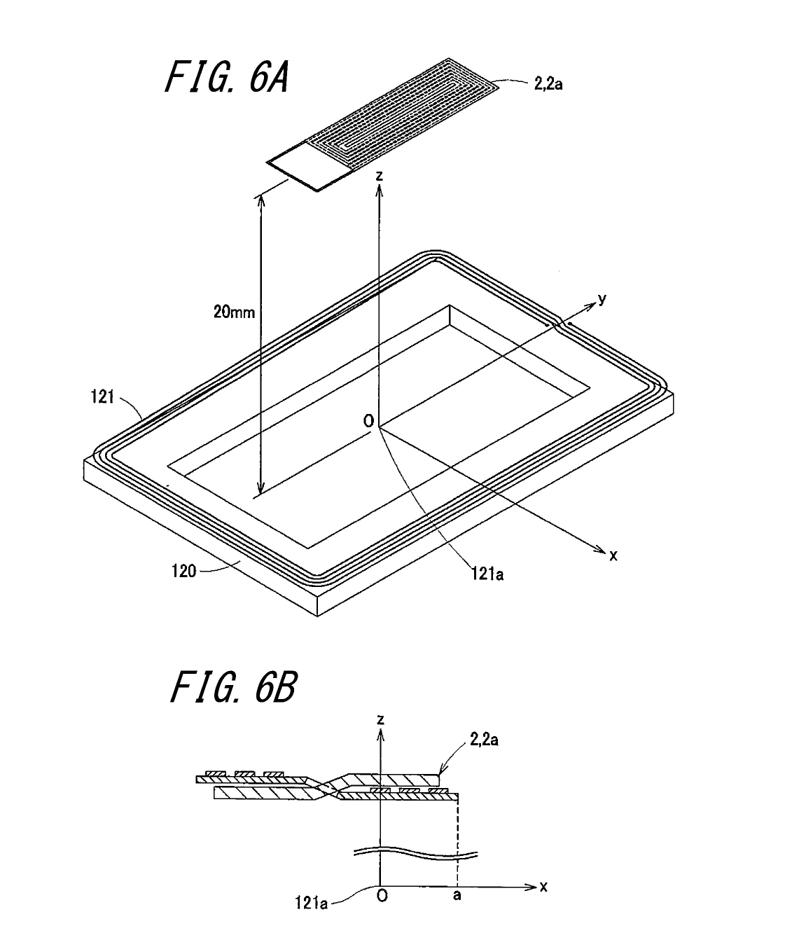

The measurement system illustrated in FIG. 6A was set up and antenna module communication characteristics were measured. Specific evaluation conditions were as follows. The antenna 121 of the reader/writer 120 was a rectangular four turn coil for which x×y=70 mm×40 mm, with the center of the reader/writer 120 set as the origin (0) 121a of the xyz coordinates. The antenna module for which communication characteristics were to be measured was placed such that an aperture of the antenna module faced the antenna 121 of the reader/writer 120 at a distance of 20 mm in the z direction from the origin (O) 121a. Relative position of the antenna module and the reader/writer 120 is defined as an offset distance a as illustrated in FIG. 6B. The offset distance a is a distance that an end part of the antenna module at a long side thereof protrudes in the x direction from the origin (O) 121a. A coupling coefficient k of the antenna coil of the antenna module and the antenna 121 of the reader/writer 120 was measured while varying the offset distance a.

<Results>

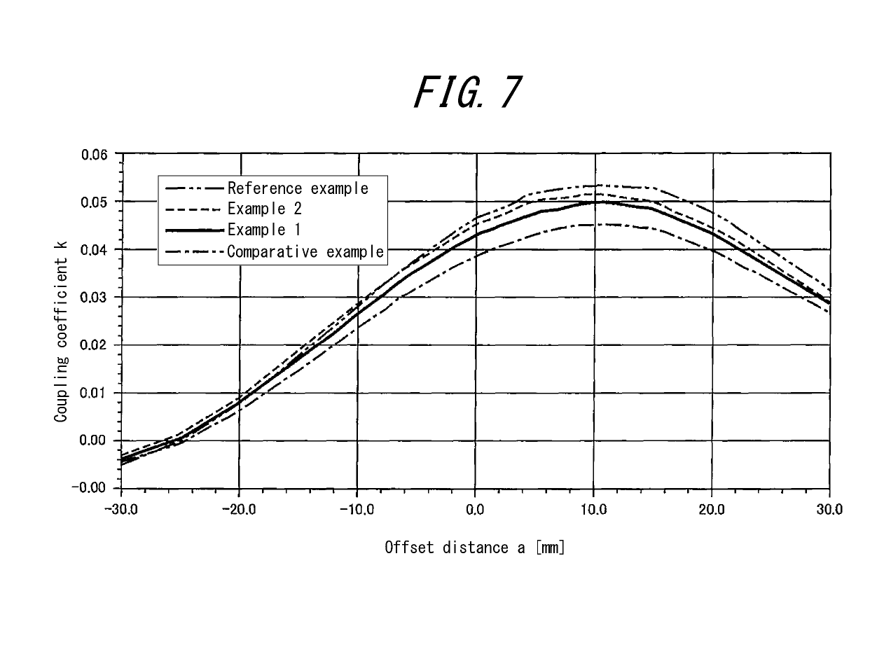

FIG. 7 is a graph plotting change in the coupling coefficient k against the offset distance a for the antenna modules having the configurations of example 1, example 2, the comparative example, and the reference example.

The antenna modules of example 1 and example 2 both achieved a high coupling coefficient relative to the antenna module of the comparative example and demonstrated good communication characteristics. Although example 1 had a lower coupling coefficient than example 2 due to only one turn looping around the outermost periphery of the antenna substrate and the remaining turn numbers being formed within the exclusive antenna coil region, rather than all four turns winding from the outermost periphery, the coupling coefficient of example 1 was still of a comparable level to the reference example.

### REFERENCE SIGNS LIST

1 communication device
2, 2a antenna module
10 exclusive antenna coil region
11 antenna substrate
11a antenna coil
13 magnetic sheet
14 slit
20 shared circuit mounting region
28 matching circuit
29 low-pass filter
30 communication processor
120 reader/writer
121 antenna
122 control substrate
130 mobile telephone

1. An antenna device incorporated into an electronic apparatus and able to communicate by receiving a magnetic field transmitted from a transmitter, comprising:
a substrate;
an antenna coil formed so as to loop around on one surface of the substrate;
a magnetic sheet inserted into a central section of the antenna coil to pull in the magnetic field transmitted from the transmitter; and
a circuit section including one or more circuit components that is located on the other surface of the substrate at a position that avoids a position at which the magnetic sheet is inserted and that is connected to an external circuit, wherein
at least part of a winding wire of the antenna coil surrounds the circuit section.

2. The antenna device of claim 1, wherein
at least a portion of the circuit components in the circuit section are surrounded by the antenna coil.

3. The antenna device of claim 1, wherein
the circuit section is a matching circuit that matches impedance with an external drive circuit.

4. A communication device incorporated into an electronic apparatus and able to communicate by receiving a magnetic field transmitted from a transmitter, comprising
an antenna device that includes:
a substrate;
an antenna coil formed so as to loop around on one surface of the substrate;
a magnetic sheet inserted into a central section of the antenna coil to pull in the magnetic field transmitted from the transmitter; and
a circuit section including one or more circuit components that is located on the other surface of the substrate at a position that avoids a position at which the magnetic sheet is inserted and that is connected to an external circuit, wherein
at least part of a winding wire of the antenna coil surrounds the circuit section.
